(19) United States
(12) Patent Application Publication
(10) Pub. No.: US 2019/0312653 A1
(43) Pub. Date: Oct. 10, 2019

(54) CHIP-IN-CONNECTOR PHOTONIC APPARATUS

(71) Applicant: Nokia Solutions and Networks Oy, Murray Hill, NJ (US)

(72) Inventors: Yee Low, Murray Hill, NJ (US); Nagesh Basavanhally, Murray Hill, NJ (US)

(21) Appl. No.: 15/946,353

(22) Filed: Apr. 5, 2018

(51) Int. Cl. H04B 10/80; G02B 6/42; H04Q 11/00

(52) U.S. Cl. CPC H04B 10/801; H04Q 11/0071; G02B 6/4277; G02B 6/4204

(57) ABSTRACT

The present disclosure is directed to an apparatus having a connector with a mating interface on one end and a coupling with an optical fiber on the other end, where the connector includes an opto-electrical device capable of communicatively coupling electrical data signals and optical data signals. In another aspect, a system is disclosed where non-optically communicative hardware components can utilize an optical fiber communication path without the need for including a light source at the hardware component or connector.

### CROSS REFERENCE TO RELATED APPLICATIONS

Some embodiments of the present application may be able to use some apparatus and/or methods disclosed in one or more of the below-listed and concurrently filed, U.S. patent applications:
U.S. application Ser. No. ______, titled “COMMUNICATION SYSTEM EMPLOYING SURFACE-COUPLED OPTICAL DEVICES”, by Ting-Chen Hu and Stefano Grillanda, Nokia Docket No. 105344-US-NP;
U.S. application Ser. No. ______, titled “OPTICAL TRANSMITTER HAVING AN ARRAY OF SURFACE-COUPLED ELECTRO-ABSORPTION MODULATORS”, by Mark Earnshaw and Stefano Grillanda, Nokia Docket No. 105324-US-NP;
U.S. provisional application No. ______, titled “REFLECTIVE OPTICAL DATA MODULATOR”, by David Neilson, Nokia Docket No. 105420-US-PSP; and
U.S. provisional application No. ______, titled “OPTICAL COMMUNICATION WITH WAVELENGTH-DEPENDENT AMPLITUDE PRE-COMPENSATION”, by Mark Earnshaw, Nokia Docket No. 105431-US-PSP.
   Each of the above-listed U.S. applications is incorporated herein, by reference, in its entirety

### TECHNICAL FIELD

This application is directed, in general, to an optical-electrical connection, and, more specifically, to an opto-electrical chip apparatus to facilitate communications.

### BACKGROUND

In traditional connector technologies, there is a need to connect an optical fiber to a non-optical fiber electrical connection, such as a coaxial cable or server, to facilitate uni-directional or bi-directional data signal communications. In order for a hardware component to communicate through the connection to a hardware component at the other end of the optical fiber, a laser, or other light source, is generally required to generate the optical signal. In addition, the components necessary to enable the connection between the hardware component and optical fiber can be of a size that causes additional packaging or form factor, in addition to higher cost.

### SUMMARY

One aspect provides an apparatus, comprising an electrically shielded cable having an end physically and electrically connected to a connector, the connector configured to optically and physically end-connect to an end of an optical fiber; and an opto-electrical device located within the connector's housing, the opto-electrical device being electrically and communicatively coupled to the cable and optically coupled to the optical fiber.

A system, comprising a connector, with a first end having a mating interface; an opto-electrical device attached to the connector, the opto-electrical device being contained within the connector's housing; an assembly physically coupled to a second end of the connector; an optical fiber, a first end housed in the assembly and optically coupled to the opto-electrical device; a light source, optically coupled to a second end of the optical fiber, and located a distance from the connector and assembly; and wherein the system is operable to provide data signal coupling between the electrical connector and the optical fiber.

### BRIEF DESCRIPTION

Reference is now made to the following descriptions taken in conjunction with the accompanying drawings, in which:

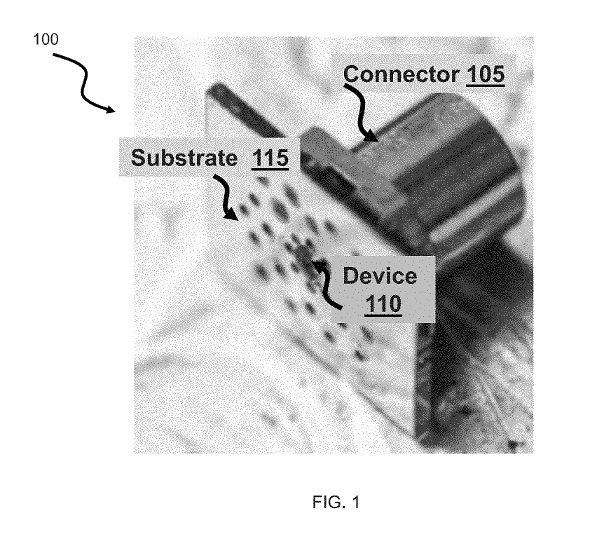

FIG. 1 is an illustration of a diagram of an example connector with an opto-electrical device mounted on a substrate;

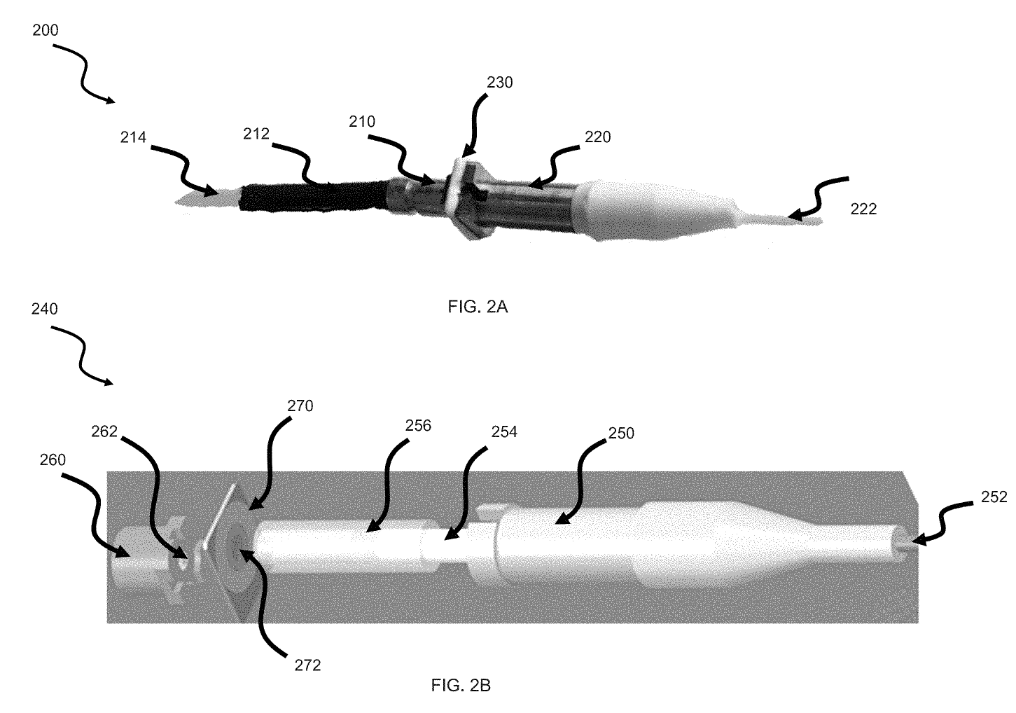

FIG. 2A is an illustration of a diagram of an example coaxial cable connector coupled to an optical fiber assembly;

FIG. 2B is an illustration of a diagram of an example part view of a connector and fiber assembly;

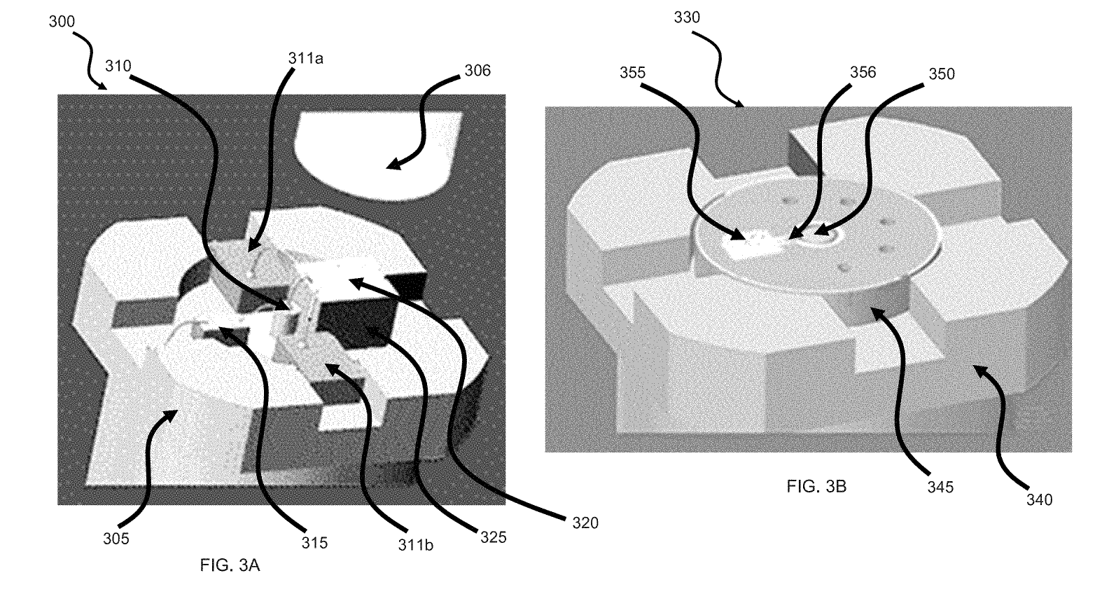

FIG. 3A is an illustration of a diagram of an example opto-electrical device coupled to a connector;

FIG. 3B is an illustration of a diagram of an example opto-electrical flip-chip device coupled to connector;

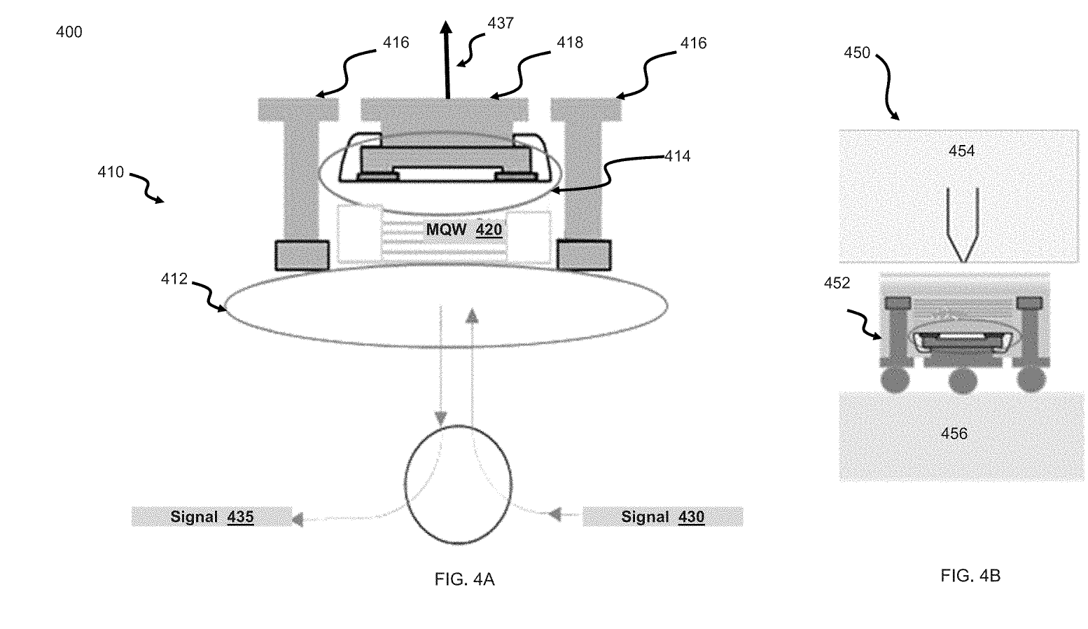

FIG. 4A is an illustration of a diagram of an example opto-electrical device;

FIG. 4B is an illustration of a diagram of an example opto-electrical flip-chip device;

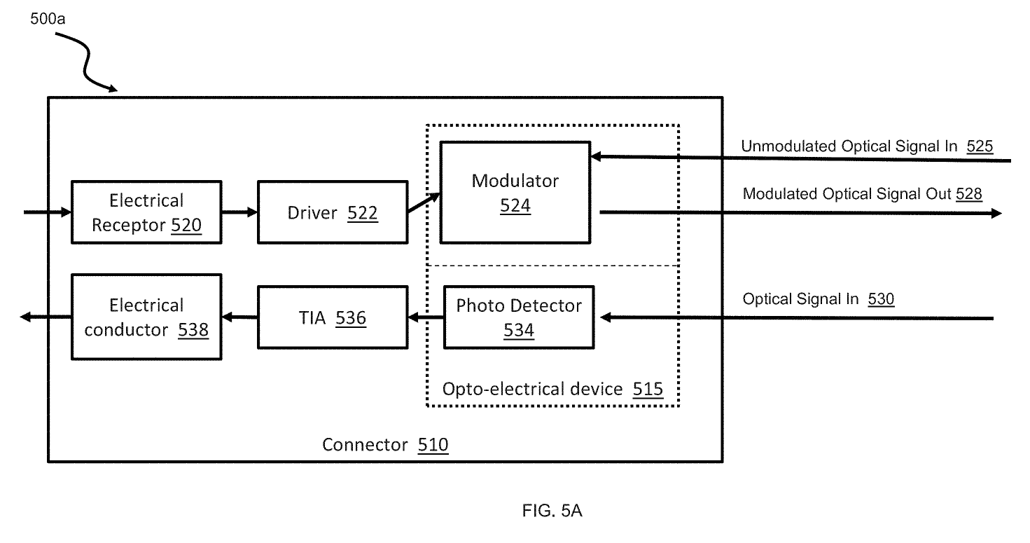

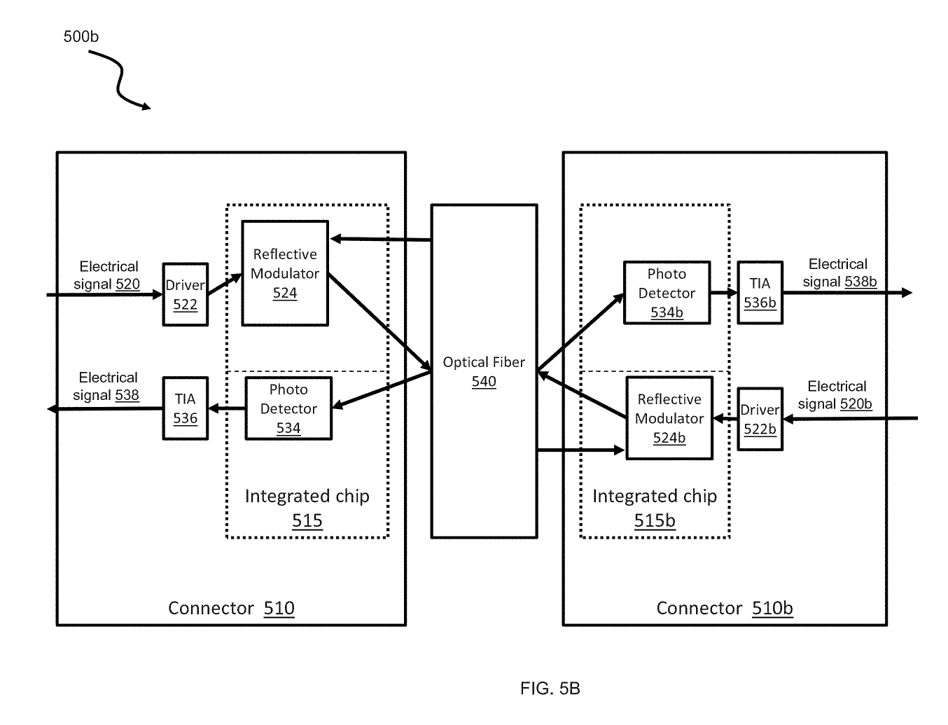

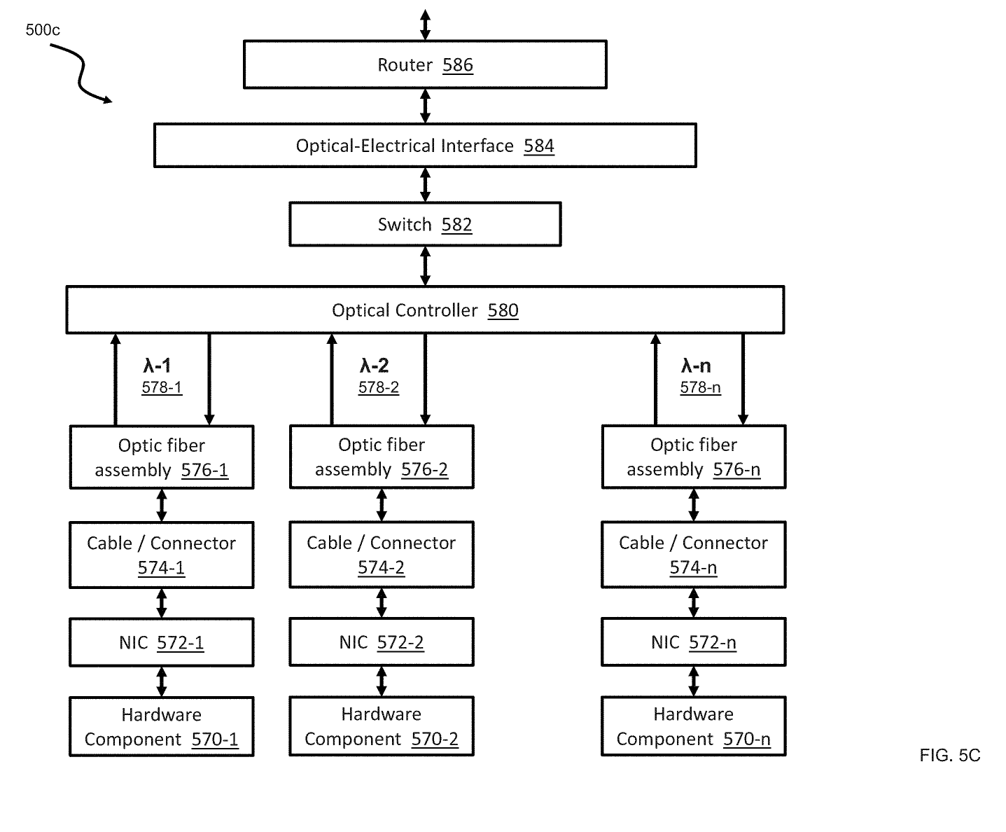

FIG. 5A is an illustration of a diagram of an example data signal system at a connector perspective;

FIG. 5B is an illustration of a diagram of an example data signal system at a connector and an optical fiber assembly perspective; and

FIG. 5C is an illustration of a diagram of an example data signal system at a hardware component perspective.

Herein, various aspects are described more fully by the Figures and the Detailed Description. Nevertheless, the disclosure may be embodied in various forms and are not limited to the aspects described in the Figures and Detailed Description of Illustrative Aspects.

### DETAILED DESCRIPTION

In various applications, such as in a data center, there can be a need to communicatively couple two or more hardware components so that they can exchange data and information. For example, a computer server, firewall, router, and other components can be communicatively coupled. The coupling can utilize various cable types, such as coaxial cable (baseband and broadband), optical fiber (multimode step index, multimode graded index, and single mode), twisted pair wire (Ethernet, cable meeting Category 3, 5, 5e, 6, 7, and 8 standards), and other types now know or later developed. There can be an advantage in utilizing an optical fiber as the throughput of data can be significantly higher than in a coaxial cable. In addition, the optical fiber can transmit signals a longer distance before signal degradation, can have a larger signal carrying capacity compared to a similar sized metal based cable, and is less prone to interference, such as radio frequency (RF) interference.

One barrier to using optical fiber to connect hardware components is that the hardware components may not be able to receive an optical data transmission and may not have a light source, such as a laser, to transmit an optical data signal. Installing a light source in hardware components can increase the cost of those components. This disclosure demonstrates a connector that is capable of electrically coupling with a hardware component and optically coupling with an optic fiber to enable hardware components to transmit and receive data signals with other hardware components while taking advantage of optical fiber benefits over a purely metal based RF cable systems.

The connector can be physically attached to the hardware component (such as with an appropriate mechanical plug interface or mechanical threading interface), or the connector can be physically attached to a separate electrical cable, which, in turn, is physically attached to the hardware components. Such a cable can be an electrical coaxial cable, twisted pair cable of various types (Ethernet cable, category x, etc.) or other cable type, which can include RF shielding.

The connector can be optically coupled to the near end of the optical fiber (see FIG. 1, example of a current connector type; and FIG. 2A, connecting a cable and optical fiber). The optical fiber can be of various types, such as single mode and multi-mode, and be constructed of plastic, glass, or other material. In order to enable conversion between the electrical signals in the electrical cable and the optical signals in the optical fiber, in the connector, an opto-electrical device (optical-electrical converter device) can be included, such as a reflective optical data modulator, a demodulator and/or an optical detector. The opto-electrical device can be mounted on a substrate, such as a flip-chip device, or be mounted directly in the connector (see FIG. 2B). The opto-electrical device can provide communication conversion between the electrical cable's electrical data signals and the optic fiber's optical data signals.

Opto-electrical devices in a connector have the device mounted on a substrate, which is mounted on the connector. This can be a large and bulky package as part of the connector. In addition, to enable transmission optical signals, a light source may need to be located proximate the connector.

In one aspect, an apparatus is demonstrated for constructing a connector, which, in some aspects, can reduce the packaging and mechanical form factor and/or can reduce performance parasitics, e.g., capacitances and/or resistances that can limit upper frequencies of the electrical communication connection. In aspects with a reflective optical modulator, a light source device is not needed at the connector to enable transmission of optical signals, because the reflective optical modulator can modulate data onto an optical carrier received from the optical fiber and reflect back to the optical fiber such a data-modulated optical carrier. In some aspects, the system allows for non-optically enabled electrical hardware components to communicate via an optical fiber without a local source of light. Such a system can enable a reduction of costs by lowering the number of expensive light sources included in the system.

An opto-electrical device, such as a reflective optical data modulator, can be mounted on a mounting block, such as a portion of a silicon chip, which is mounted on the electrical connector's surface (see FIG. 3A). The reflective optical data modulator can be driven by electrical power received from the hardware component. The electrical driver of the reflective optical modulator can receive a data stream, such as a modulated electrical signal, e.g., an RF signal, from a local hardware component via a wire or cable and then modulate light received from the optical fiber, with said data stream, to send a data-modulated optical signal back through the same optical fiber providing the light.

In some aspects, the connector can include a photo-detector and related electronics to receive a data-modulated optic signal from the optic fiber and convert the data-modulated optical signal to a data-modulated electronic signal for communication to the local hardware component. The photo-detector can be in the same connector as the reflective optical modulator, but laterally separated therefrom. In other aspects, a different connector can include such a photo-detector and related processing electronics, and the different connector would connect to a different optical fiber for receiving a data stream at the same local hardware component.

Using wire bonding attachment methods, the opto-electrical device can be electrically coupled to the connector and further electrically connected to an electrical coaxial cable end-attached to the connector, if present. By eliminating the substrate, the form factor and packaging can be reduced, thereby reducing costs and size. The package and mechanical form factor can be smaller than the lateral size of the connector housing, e.g., where the opto-electrical device is laterally contained in the end of the connector. In addition, the distance the electronic signals travel can be reduced. The shortening of such distances can improve the rate or speed at which data can be transmitted electrically. In aspects where there are fewer components and shorter distances traveled for the electrical communication signals, a reduction of high-frequency performance parasitics can be possible.

In some aspects, an opto-electrical flip-chip device can be mounted on a substrate, while the substrate size is reduced to fit within the lateral boundaries of the connector housing (see FIG. 3B). Since the substrate is contained within the lateral confines of the connector housing, there is no additional packaging or size requirements for the combined connector. The connector's signal pin can be uncovered by the substrate, which can allow the flip-chip device to be wire bonded to the signal pin. This has the advantage of having a shorter electronic path to follow while maintaining the flip-chip device's engineering constructs.

The opto-electrical device can be located proximate to and electrically coupled to one or more metal contacts, such as grounding pads, located within the connector housing. The metal contacts can be electrically connected to connect the opto-electrical device across electrical leads of the electrical cable connected to the local hardware component, e.g., across the outer electrical shield and core wire of an electrical coaxial cable.

An end of an optical fiber can be placed to face and be proximate to the opto-electrical device and aligned to the opto-electrical device to provide appropriate communication coupling. Alignment adjustments can be made to the optical fiber-connector coupling interface and to the connector. The connector can include one or more adjustment mechanisms for lateral, angle, and/or depth adjustments to achieve a satisfactory optical coupling. One end of the optical fiber can be housed within an assembly, which can include, e.g., a lens such as a graded refractive index (GRIN) lens to focus light from the end of the optical fiber onto the opto-electrical device.

The opto-electrical device, can be a surface-coupled reflective optical modulator, which can have the advantage of polarization independence, i.e., provided that the input signal is normally incident thereon.

The described connector can be part of a data signal communication system. For example, a connector, attached to a hardware device, can be coupled with an optical fiber, which in turn is coupled to an optical signal source. The optical signal source can include, but is not limited to, for example, one or more light sources, such as laser(s). These functions can be combined in various combinations and can be located in one or more separate components.

For example, the optical signal source can receive a data signal, which can be optical or alternatively, electrical, and generate an optical signal that is transmitted along the optical fiber. In an alternative, the optical signal source can send a specific set of one or more unmodulated wavelengths of light and can include a wavelength demultiplexer that sends different ones of the wavelengths of light to different connectors electrically connected to corresponding hardware components. Each connector can modulate the received unmodulated wavelength of light using the reflective optical modulator therein and transmit the modulated wavelength of light back into the same optical fiber. Alternately, the connector, or opto-electrical device of a connector, can transform a received data modulated wavelength of light into a corresponding data modulated electrical signal sent to the local hardware component.

Turning now to the figures, FIG. 1A is an illustration of a diagram 100 of a connector with a device mounted on a substrate. This is an example of a typical flip-chip device 110, such as a modulator or other device type, bonded to a substrate 115. The reverse side of substrate 115 is soldered to a connector 105. Holes in the substrate 115 allow for electronic connections for the signal and metal connections, such as for a ground connection, from the connector 105 to the solder pads on the top surface where the device is bonded. In this example, substrate 115 is rectangular in shape and is larger than the connector's 105 housing.

FIG. 2A is an illustration of a diagram 200 of a coaxial connector coupled to an optic fiber assembly. Connector 210 houses one end of a coaxial cable 214 which has an electronically shielded (i.e., RF shielded) protective sheathing 212. Assembly 220 houses one end of an optical fiber 222. Connector 210 and assembly 220 are coupled at a join 230. Inside of the connector 210 is a microelectronic device (i.e., the opto-electrical device) capable of communicatively coupling the coaxial cable 214 and the optical fiber 222. In an alternate aspect, the connector 210, in place of the cable 214, can have an appropriate physical mating interface to connect to a hardware component. The hardware component can be a data server, a server rack system, for example, a top of rack component, an end of server rack row component, or other types of hardware components, such as routers, switches, and firewalls.

FIG. 2B is an illustration of a diagram of an example part view 240 of a connector and optical fiber assembly. Assembly 250 houses one end of an optical fiber 252. Optical fiber 254, shown with a sheath 256, can be the same or different optical fiber as 252. If different, optical fiber 254 is optically coupled to optical fiber 252. Connector 260 is shown with a signal pin 262. Substrate 270 is shown with a flip-chip device 272 mounted in the middle of the substrate.

FIG. 3A is an illustration of a diagram of an example opto-electrical device 300 electrically wire bonded directly to a connector. Connector housing 305 contains one or more electrical ground pads 311a and 311b, an electronic device 315, such as a RF termination resistor, and one or more electronic signal pins 310. Opto-electrical device 320 is mounted on block 325, and block 325 is attached, such as with epoxy, adhesive, thermal compounds, and other types of attachment mechanisms, to connector 305. Optical fiber end 306 is shown above connector 305 for clarity. Optical fiber 306, under normal operation, can be placed and aligned in conjunction with opto-electrical device 320 to allow for communication coupling.

Opto-electrical device 320 is shown, in this example, to be wire bonded to ground pads 311a and 311b and signal pin 310. Signal pin 310 is shown, in this example, to have a wire bond to another electronic device 305, such as a resistor. Block 325 can be of a type of mounting block suitable for the device 320 and connector 325, such as silicon, ceramic, and other type of material. For demonstration purposes, diagram 300 shows a single opto-electrical device, two ground pads, a single signal pad, and one additional electronic device. In other aspects, the number of ground pads, signal pins, opto-electrical devices, and additional electronic devices can vary depending on the purpose and usage of the connector. For example, an array of signal pins can be included, each communicatively coupled to one or more respective devices. In another aspect, one or more lenses can be included to optically couple the near end of the optical fiber to the opto-electrical device.

FIG. 3B is an illustration of a diagram of an example opto-electrical flip-chip device 330 mounted on a substrate and partially wire bonded to connector. Connector housing 340 contains, within the connector housing 340, a substrate 345. Substrate 345 has a flip-chip device 355 mounted on the top surface, with flip-chip device's 355 ground wires attached to electronic points on substrate 345. Substrate 345 has electronic points on the underside that electronically couple to the connector's 340 ground pads. In this example, flip-chip device 355 is wire bonded (shown as 356) to connector's 340 signal pin 350. In other aspects, the flip-chip device's 355 signal wire can be electronically coupled to the connector 340's signal pin through the substrate 345, similar to how the ground pads are connected.

Substrate 345 can be of a suitable material, such as silicon, ceramic, and glass, and in other aspects, other materials can be utilized. For demonstration purposes, device 330 shows a single opto-electrical device, one substrate, and a single signal pad. In other aspects, the number of signal pins, devices, and substrates can vary depending on the purpose and usage of the connector. In additional aspects, additional components can be included, such as one or more lenses.

FIG. 4A is an illustration of a diagram 400 of an example opto-electrical device 410 that can be attached in the previously described connectors, as opto-electrical devices 320 and 355. Opto-electrical device 410 includes an optical cavity having a front mirror 412, a back mirror 414, one or more metal contacts 416, such as for electrical grounding and biasing, and a sequence of quantum well (QW) layers 420 between the mirrors 412, 414, which limit the optical cavity. Opto-electrical device 410 also includes an electrical component 418. Mirrors 412 and 414 can be dielectric or metal coatings on the opto-electrical device 410. Optical signal 430 is received by the opto-electrical device 410 from the near-end of an optical fiber. Optical signal 430 is typically an unmodulated light signal of one wavelength, e.g., a continuous wave (CW) laser signal. Depending on the opto-electrical device 410, received light signal can be modulated by the opto-electrical device 410 and reflected back the near-end of the optical fiber, e.g., shown as signal 435.

Opto-electrical device 410 can be a reflective optical data modulator, an optical data demodulator, reflector (including MEMS mirrors), and other device types. Opto-electrical device 410 can be packaged as a chip/block device (as shown in FIG. 3A), a flip-chip device (as shown in FIG. 3B), or a combination thereof. Opto-electrical device 410 can be a combined device, in various combinations, such as an optical data modulator, and an optical data demodulator. Opto-electrical device 410 can include additional features and functionality appropriate to operate. For example, opto-electrical device 410 can include an optically responsive surface (major surface). Opto-electrical device 410 can include a lens that can be configured to focus an optical signal from the near end of the optical fiber onto the major surface. In another aspect, the lens can be included within the connector as a separate component from the opto-electrical device 410.

FIG. 4B is an illustration of a diagram of an example flip-chip opto-electrical device 450. Flip-chip 452 is shown bonded to substrate 456 and with an optical connection to optical circuit chip 454. Flip-chip 452 can be of various types of opto-electrical devices, for example, an optical data modulator, an optical data demodulator, reflector, and a photo-detector.

FIG. 5A is an illustration of a block diagram of an example data signal system 500a at a connector perspective. Connector 510 can include one or more of the components, the components can be combined or separated physically, and some components can be located external to the connector 510. The potential components of connector 510 can be an electrical receptor 520 that can receive an electrical signal stream from an external source. Electrical receptor 520 can include a metal contact within the connector 510 and include an electronic circuit for converting the received electric signal stream into a stream of signals appropriate for a driver 522 of the opto-electric device 515.

Opto-electric device 515 can include a device of various types, in this example, an optical data modulator 524 is shown. The optical data modulator 524 can be operated by the electrical signal from driver 522 and responsively reflectively modulate an incoming continuous or pulsed light source 525. Optionally, there can be a lens. The resulting optical signal 528 is passed on to the optical fiber.

A reverse directional flow is also demonstrated. Optical signal 530 can be received by opto-electric device 515. Photo detector 534 receives the optical signal 530 and then passes an electrical signal to a transimpedance amplifier (TIA) which can send the electrical signal to an electrical conductor 538. Electrical conductor 538 can be a metal contact or an electronic circuit capable of transmitting an electronic signal. The electronic signal is passed out of connector 510. This example shows a modulator 524 and a photo detector 534 in the same opto-electrical device 515. These components can be separated into different opto-electrical devices, as shown by the dotted line separating the components.

FIG. 5B is an illustration of a block diagram of an example data signal system 500b at a connector and optical fiber assembly perspective. System 500b is similar to system 500a and the component discussions shown in system 500a will not be repeated here. System 500b is showing two connectors 510 and 510b connected through an optical fiber component 540. This system example shows that bi-directional communications can be established between components that are generating and receiving the electrical signals 520, 520b, 538, and 538b, while a portion of the communications is carried over an optical fiber medium. Optical fiber component 540 can include an optical controller and a light source to enable optical signal transmissions.

FIG. 5C is an illustration of a block diagram of an example data signal system 500c showing interconnections between various hardware components. The system 500c can include one or more hardware components 570, network interface cards (NIC) 572, cable/connectors 574, optic fiber assemblies 576, optical controller 580, switch 582, optical electrical interface 584, and router 586. Other components can be included in this system, for example, switches and firewalls. In some aspects, the components listed do not need to be present to make the system operable. The system 500c describes a system where a hardware component can communicate with a second hardware component using an optical fiber medium where there is a light generating apparatus (light source) separate from the hardware components.

There can be one or more hardware components 570. Hardware component 570 can be, for example, a server, a top of rack component, an end of rack component, switch, firewall, WIFI router, WIFI extender, and other type of components that may have a need to communicate with other hardware components. Hardware component 570 can have a NIC 572 internal or external to the hardware component, where the NIC 572 can provide for a bi-directional electrical signal communication. Cable/connector 574 can be physically and electrically attached to the NIC 572. Cable/connector 574 can have a cable, such as a coaxial or Ethernet cable, that can be attached to the NIC 572. In an alternative aspect, the connector 574 can be attached directly to the NIC 572 without a cable. Cable/connector 574 can include an opto-electrical device as described in 320, 355, 410, and 450.

Cable/connector 574 can be physically and optically attached to one end of an optic fiber assembly 576. The other end of optic fiber assembly 576 can be physically and optically attached to an optical hardware component, such as an optical controller component 580. Optical controller 580 can modulate (MUX) and demodulate (DMUX) an optical signal. Optical controller 580 can contain a light source, such as a laser, that can generate an optical signal through optical fiber assembly 576. In some aspects, optical controller 580 can be able to act as a wavelength splitter of the light source. Certain light wavelengths can be transmitted along different optical fiber paths, as shown as λ578. In some aspects, the opto-electrical device contained in the connector 574 can be configured to respond to a selected set of wavelengths and ignore other wavelengths.

Optical controller 580 can be optically connected to an optional 1×2 optical switch 582. If present, optical switch 582 can be optically connected to an optical-electrical interface 584. If not present, optical controller 580 can be optically connected to optical-electrical interface 584. Optical-electrical interface 584 is capable of converting optical signals to electrical signals and the reverse. Optical-electrical interface 584 can be electrically connected to a router 586. Router 586 can be further electrically connected, for example, to other hardware components, a local area network, and a wide area network.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described aspects. It is also to be understood that the terminology used herein is for the purpose of describing particular aspects only, and is not intended to be limiting, since the scope of the disclosure will be limited only by the claims.

Unless defined otherwise, all technical and scientific terms used herein have the same meaning as commonly understood by one of ordinary skill in the art to which this disclosure belongs. Although various methods and materials similar or equivalent to those described herein can also be used in the practice or testing of the present disclosure, a limited quantity of the exemplary methods and materials are described herein.

It is noted that as used herein and in the appended claims, the singular forms “a”, “an”, and “the” include plural referents unless the context clearly dictates otherwise.

1. An apparatus, comprising:
a connector;
an electrically shielded cable having an end physically connected to the connector, the connector being configured to physically connect an optical fiber to the cable; and
an opto-electrical device located within a housing of the connector, the opto-electrical device being electrically and communicatively coupled to the cable and being configured to optically couple to the optical fiber such that the end of the optical fiber faces the opto-electrical device.

2. The apparatus of claim 1, wherein the opto-electrical device includes a reflective optical data modulator connected to receive an electrical signal from the cable, the reflective optical data modulator being configured to modulate light from the optical fiber and to direct the modulated light to the optical fiber.

3. The apparatus of claim 2, wherein the reflective optical data modulator is an integrated opto-electrical structure and is configured to optically couple to the end of the optical fiber via a major surface of the integrated opto-electrical structure.

4. The apparatus of claim 3, further comprising a lens configured to focus an optical signal from the optical fiber onto the major surface.

5. The apparatus of claim 1, further comprising the optical fiber.

6. The apparatus of claim 5, wherein the opto-electrical device includes a reflective optical data modulator electrically connected to the cable, the reflective optical data modulator being configured to modulate light received from the optical fiber and to direct said modulated light to the optical fiber.

7. The apparatus of claim 1, wherein the opto-electrical device is a flip-chip device and is physically connected to a substrate, and the substrate is contained within the connector.

8. The apparatus of claim 5, wherein the opto-electrical device communicatively couples the optical fiber and an electrical coaxial cable.

9. The apparatus of claim 1, wherein the opto-electrical device is an optical detector.

10. The apparatus of claim 1, wherein the connector includes an array of signal pins, each of the pins being communicatively coupled to a separate optic-electro device.

11. A system, comprising:
a connector, with a first end having a mating interface;
an opto-electrical device attached to the connector, the opto-electrical device being in the connector;
an assembly physically coupled to a second end of the connector;
an optical fiber having a first end housed in the assembly and being optically coupled to the opto-electrical device, the first end of the optical fiber facing the opto-electrical device; and
a light source, optically coupled to a second end of the optical fiber, and located a distance from the connector and assembly.

12. The system as recited in claim 11, further comprising:
a coaxial cable having a first end coupled to the mating interface and being electrically coupled to the opto-electrical device.

13. The system as recited in claim 11, wherein the opto-electrical device is electrically coupled to a server.

14. The system as recited in claim 11, wherein the opto-electrical device is electrically coupled to a server rack system.

15. The system as recited in claim 11, wherein the light source includes a wavelength splitter and the opto-electrical device is configured to respond to a selected set of wavelengths.

16. The system as recited in claim 15, wherein the system further comprises:
a second connector;
a second opto-electrical device being attached to the second connector and being in the second connector;
a second optical fiber having an end optically coupled to the opto-electrical device, the end of the second optical fiber facing the second opto-electrical device; and
wherein the second opto-electrical device is configured to receive a separate set of wavelengths.

17. The system as recited in claim 11, further comprising a lens configured to focus an optical signal from the optical fiber onto a major surface of the opto-electrical device.

18. The system as recited in claim 11, wherein the opto-electrical device is a reflective optical data modulator.

19. The system as recited in claim 11, wherein the opto-electrical device is an optical detector.

20. The system as recited in claim 11, wherein the opto-electrical device is flip-chip mounted on a substrate within the connector.

21. An apparatus, comprising:
a server;
an optical fiber;
a mating interface physically connected to the server, the mating interface physically connecting the optical fiber to the server; and
an opto-electrical device located within the mating interface, the opto-electrical device being electrically and communicatively coupled to the cable and being optically coupled to the optical fiber such that the end of the optical fiber faces the opto-electrical device.

22. The apparatus of claim 21, wherein the opto-electrical device includes a reflective optical data modulator being electrically connected the server, the reflective optical data modulator being configured to modulate light from the optical fiber and to direct said modulated light to the optical fiber.
